(19) United States
(12) Patent Application Publication
(10) Pub. No.: US 2012/0225766 A1
(43) Pub. Date: Sep. 6, 2012

(54) TUBE AND FLOAT SYSTEMS FOR DENSITY-BASED FLUID SEPARATION

(76) Inventors: Ronald C. Seubert, Sammamish, WA (US); Paul C. Goodwin, Shoreline, WA (US); Martha Stone, Woodinville, WA (US)

(21) Appl. No.: 13/409,453

(22) Filed: Mar. 1, 2012

Related U.S. Application Data
(60) Provisional application No. 61/448,277, filed on Mar. 2, 2011.

(51) Int. Cl. B01D 43/00

(52) U.S. Cl. 494/37; 422/533

(57) ABSTRACT

This disclosure is directed to tube and float systems that can be used to detect target materials in a variety of different suspensions. The tube is filled with a suspension suspected of containing a target material. When the tube, a float, and suspension are centrifuged, and the various materials suspended in the suspension are separated into different material layers along the axial length of the tube according to associated specific gravities. The float includes an insert and a float exterior that can be combined so that the float is to be positions at approximately the same level as the layer containing the target material. The float is to be positioned in, and expand the axial length of, the target material layer so that nearly the entire quantity of target material is to be positioned between the float outer surface and the inner surface of the tube.

### CROSS-REFERENCE TO RELATED APPLICATION

This application claims the benefit of Provisional Application No. 61/448,277, filed Mar. 2, 2011.

### TECHNICAL FIELD

This disclosure relates generally to density-based fluid separation and, in particular, to tube and float systems for the separation and axial expansion of constituent suspension components layered by centrifugation.

### BACKGROUND

Whole blood is a suspension of particles (e.g., red blood cells and white blood cells) in a proteinaceous liquid (plasma). Whole blood is routinely examined for the presence of abnormal organisms or cells, such as cancer cells, ova, parasites, microorganisms, and inflammatory cells. Blood is typically analyzed by smearing a sample on a slide and is stained and visually studied usually by bright field microscopy, and then, if needed, by immunologic stains and/or other molecular techniques. Visual detection of cancer cells and other abnormal organisms in smears is often hindered by the presence of extraneous materials interspersed between cells. Additionally, standard smear preparations utilize only a fraction of the sample since the smears must be thin enough to allow the passage of light, but the examination of an entire blood sample across multiple smears is often impractical and cost prohibitive in most laboratory settings. Consequently, the sensitivity of disease detection can be limited by the smear methodology.

Whole blood samples can also be collected to detect a variety of different viruses. For example, HIV, cytomegalovirus, hepatitis C virus, and Epstein-Barr virus can be detected in blood samples using polymerase chain reaction (“PCR”)-based or serologic tests. Although PCR-based tests are sensitive and quantitative, PCR-based tests can be cost prohibitive and imprecise because they may detect contaminants or other cross-reacting sequences in the blood sample. Serology on the other hand can also be used to detect the presence of certain viruses, but serology does not provide quantitative information, such as determining how much of a virus is present.

Practitioners, researchers, and those working with suspensions continue to seek systems and methods for accurately analyzing suspensions for the presence or absence of various kinds of particles.

### SUMMARY

Tube and float systems that can be used to detect target materials in a suspension are disclosed. A suspension suspected of containing a target material is added to the tube. A float is also added to the tube, and the tube, float, and suspension are centrifuged together, causing the various materials suspended in the suspension to separate into different layers along the axial length of the tube according to their specific gravities. The float includes an insert and a float exterior, where the insert is inserted into the float exterior to create an air gap. The float is also programmable in that the specific gravity of the float can be programmed by selecting appropriate masses and volumes for the insert and float exterior and an appropriate volume of the air gap. As a result, the float can be programmed to have a specific gravity that positions the float at approximately the same level as the layer containing the target material when the tube, float and suspension are centrifuged. When the target material is present, the float is positioned in and expands the axial length of the layer containing the target material so that nearly the entire quantity of target material is ideally positioned between the float outer surface and the inner surface of the tube, enabling nearly the entire quantity of target material contained in the sample to be analyzed.

### BRIEF DESCRIPTION OF THE DRAWINGS

FIG. 1 shows an isometric view of an example tube and float system.

FIG. 2 shows an enlarged isometric view of the example float shown in FIG. 1.

FIG. 3A shows a cross-sectional view of the tube and float system along a line I-I, shown in FIG. 1.

FIGS. 3B-3I show cross-sectional views of example floats.

FIG. 4A shows an example of the tube and float system, shown in FIG. 1, used to trap and spread a buffy coat of an anticoagulated whole blood sample.

FIG. 4B shows a flow diagram summarizing a method of expanding a layer containing a target material of a suspension.

FIGS. 5A-5B show isometric and cross-sectional views of an example float with an insert and float exterior sealed with a gasket.

FIGS. 6A-6B show isometric and cross-sectional views of a screw-fit float with a threaded plug insert and float exterior with a threaded opening.

FIGS. 6C-6D show isometric and cross-sectional views of a screw-fit float with an insert and float exterior sealed with a gasket.

FIGS. 7A-7C show isometric, top, and cross-sectional views of a float with a float exterior including bore holes.

FIGS. 8A-8B show isometric and cross-sectional views of an example float.

FIG. 9 shows isometric views of an example float with an insert including a scale.

FIGS. 10A-10C show three different views of an example float with a locking mechanism.

FIGS. 11A-11C show isometric and cross-sectional views of an example screw-fit float with a threaded insert and float exterior with a threaded opening.

FIGS. 12A-12E each show examples of geometric shapes for insert end caps.

FIGS. 13A-13C show examples of three geometric shapes for float exterior end caps.

FIGS. 14-24 show eleven different examples of float exterior structures.

### DETAILED DESCRIPTION

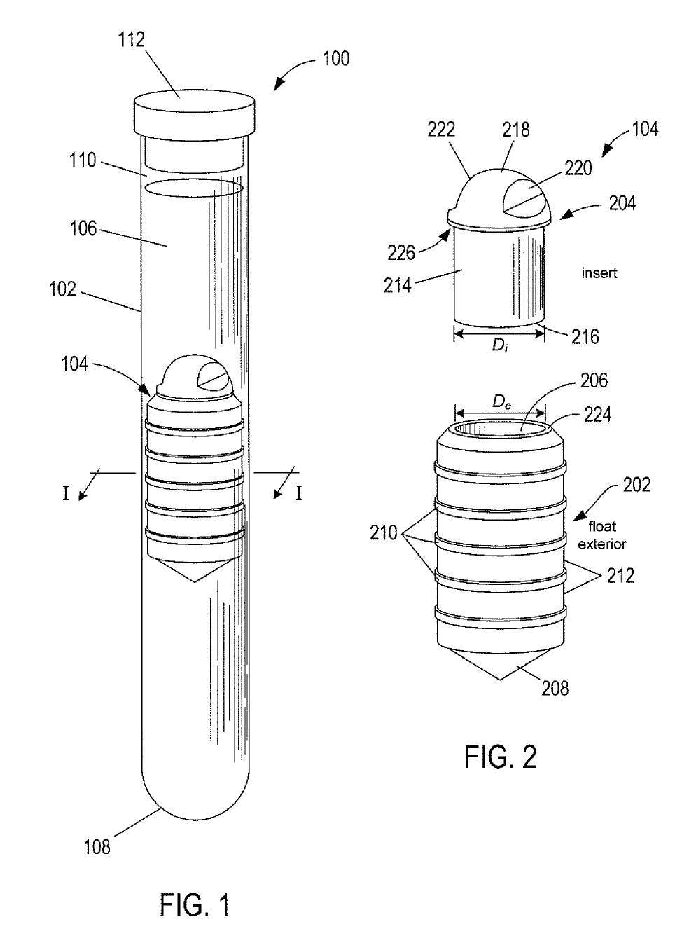

FIG. 1 shows an isometric view of an example tube and float system 100. The system 100 includes a tube 102 and a programmable float 104, which is shown suspended within a suspension 106. The suspension 106 is a fluid containing particles that are sufficiently large for sedimentation. Examples of suspensions include paint, urine, anticoagulated whole blood, and other bodily fluids. A target material can be cells or particles whose density equilibrates when the suspension is centrifuged. Examples of target materials found in suspensions obtained from living organisms include cancer cells, ova, inflammatory cells, viruses, parasites, and microorganisms, each of which has an associated specific gravity. The tube 102 has a circular cross-section, a first closed end 108, and a second open end 110. The open end 110 is sized to receive a stopper or cap 112, but the open end 110 can also be configured with threads (not shown) to receive a threaded stopper or screw cap 112 that can be screwed onto the open end 110. The tube 102 can also include two open ends that are both sized to receive stoppers or caps. As shown in FIG. 1, the tube 102 has a generally cylindrical geometry, but may also have a tapered geometry that widens toward the open end 110. The tube 102 can be composed of a transparent or semitransparent material, such as plastic or another suitable material. Although the tube 102 has a circular cross-section, in other embodiments, the tube 102 can have an elliptical, a triangular, a square, a rectangular, an octagonal, or any other suitable cross-sectional shape that substantially extends the length of the tube.

FIG. 2 shows an enlarged isometric view of the programmable float 104. The float 104 includes a float exterior 202 and an insert 204. The float exterior 202 includes a cylindrical-shaped opening 206, a closed, cone-shaped tapered end 208, and five rings 210 also called “ribs” with approximately equal diameters that are greater than the diameter of the main body 212. The ribs 210 may be separately formed and attached to the main body 212, or the ribs 210 and the main body 212 can form a single structure. The ribs 210 create annular-shaped channels that are bounded by the ribs 210 and the main body 212. In alternative embodiments, the number of ribs, rib spacing, and rib thickness can each be independently varied. In the example shown in FIG. 2, the insert 204 has a cylindrical-shaped plug or stopper 214 with an end 216 and a dome-shaped head 218 including finger grips 220 and 222 notched into the head 218. The float exterior 202 includes a ledge 224 that forms a seal with a flat annular-shaped surface 226 surrounding the base of plug 214. In FIG. 2, the diameter of the plug 214 is denoted by Dᵢ and the diameter of the opening 206 is denoted by Dₑ. In certain embodiments, the plug 214 can have a larger diameter than the opening 206 (i.e., Dᵢ>Dₑ) creating a negative clearance. As a result, the plug 214 is pressed into the opening 206 where frictional forces between the inner wall of the opening 206 and outer surface of the plug 214 hold the insert 204 in place. In another embodiment, the plug 214 can have approximately the same diameter as the opening 206 (i.e., Dᵢ<Dₑ) creating a zero clearance when the plug 214 is inserted into the opening 206. Frictional forces between the inner wall of the opening 206 and outer surface of the plug 214 may also be a factor in holding the insert 204 in place. In another embodiment, the diameter of the plug 214 can be less than the diameter of the opening 206 (i.e., Dᵢ<Dₑ) creating a positive clearance when the plug 214 is inserted into the opening 206.

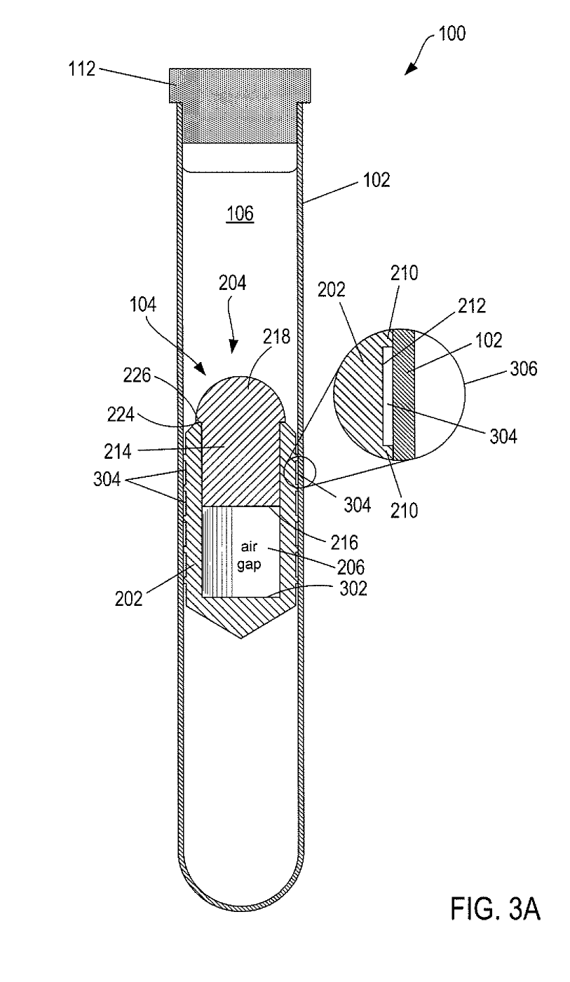

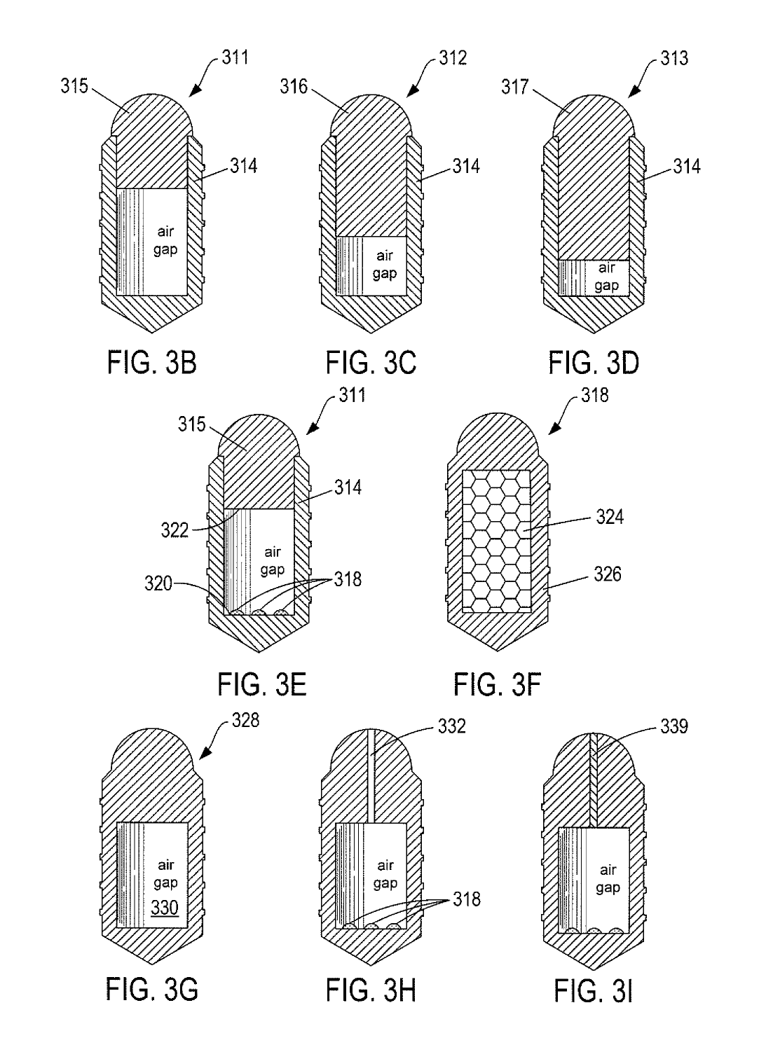

FIG. 3A shows a cross-sectional view of the tube 102 and float 104 along a line I-I, shown in FIG. 1. As shown in FIG. 3, the plug 214 is placed within the opening 206 such that the ledge 224 of the float exterior 202 forms a seal with the surface 226 of the head 218. Because the length of the plug 214 extends part of the length of the opening 206, an air gap is created between the end 216 of the plug 214 and the bottom 302 of the opening 206. The length or mass of the plug 214 and volume of air trapped in the air gap, which operates like a bubble, contribute to the specific gravity of the float 104. The specific gravity for the float 104 can be approximated by the equation

$$S {G}_{float} \approx \frac{{m}_{cyl} + {m}_{in} + {m}_{air}}{( {v}_{cyl} + {v}_{in} + {v}_{air} ) {ρ}_{water}}$$

where m_{cyl} is the mass of the float exterior 202;

mᵢₙ is the mass of the insert 204;

mₐᵢᵣ is the mass of air trapped in the air gap;

v_{cyl} is the volume of the float exterior 202;

vᵢₙ is the volume of the insert 204;

vₐᵢᵣ volume of the air gap; and

ρ_{water} is the density of water.

Decreasing the volume vₐᵢᵣ increases the specific gravity of the float 104 and the float 104 becomes less buoyant in the suspension 106. On the other hand, increasing the volume vₐᵢᵣ decreases the specific gravity of the float 104 and the float 104 becomes more buoyant in the suspension 106. Note also the length of the plug increases the mass mᵢₙ of the insert 104. The float 104 is called a “programmable float” because the specific gravity or buoyancy of the float 104 can be set by selecting the insert 204 and the float exterior 202 with appropriate masses mᵢₙ and m_{cyl} and selecting the insert 204 and float exterior 202 with appropriate volumes vᵢₙ and v_{cyl}. The float 104 can also be programmed with a particular specific gravity by selecting the insert 204 and exterior 202 to produce an air gap with a particular volume vₐᵢᵣ.

FIGS. 3B-3D show examples of floats programmed with different specific gravities based on just selecting the volume of the air gap vₐᵢᵣ and mass mᵢₙ of the insert. The float 311-313 shown in FIGS. 3B-3D each have the same float exterior 314. In the examples of FIGS. 3B-3D, it is assumed that the inserts 315-317 used to program the floats 311-313 with a particular specific gravity are composed of the same materials. In the example of FIG. 3B, the insert 315 has the shortest plug length, produces the greatest air gap volume, and has the lowest mass. Therefore, the float 311 has the lowest specific gravity and is the most buoyant of the three floats. At the other extreme shown in the example of FIG. 3D, the insert 317 has the longest plug length, produces the smallest air gap volume, and has the greatest mass. Therefore, the float 313 has the greatest specific gravity and is the least buoyant of the three floats. In the example shown in FIG. 3C, the float 312 has a specific gravity and buoyancy that lies somewhere between the specific gravities and buoyancies of the other two floats 311 and 313, because the insert 316 has an intermediate plug length that produces an air gap with an intermediate volume and has a mass between the masses of the inserts 315 and 317.

Alternatively, the mass of the float 311 can be changed with the addition of materials to the float exterior opening. One embodiment includes the addition of droplets of an adhesive to the opening of the float exterior 314 and/or the insert 315. For example, FIG. 3E shows a cross-sectional view of the float 311 with droplets 318 of adhesive disposed on the floor 320 of the float exterior 314. Mass can also be added to the float 311 with droplets of the adhesive disposed on the base surface 322 of the plug of the insert 315. Note also that the mass of the float 311 can be increased with wafers disposed on the floor of the opening in the float exterior or by inserting a plug that at least partially fills the air gap. The mass and shape of the wafers or plug can be selected to add a calibrated mass to the float 311.

Alternatively, the mass of a float can be selected by forming the float 104 from different materials. FIG. 3F shows an example float 318 with a core 324 composed of a first material surrounded by a shell 326 composed of a second material from which the main body and ends of the float 318 are molded. For example, the core 324 can be composed of Styrofoam® or a honeycomb structure and the shell 326 can be composed of Dekin®.

Alternatively, programmable floats can be composed of a single piece of material with an air gap in the interior. FIG. 3G shows a cross-sectional view of float 328 formed from a single piece of material with an air gap 330. The float 328 can be formed with the air gap 330 during fabrication, or the float 328 can represent the float 311 after the insert 315 has been sealed to the float exterior 314 to form a single piece float. In order to increase the mass of the float 328, a passage 332 can be formed, such as by drilling, in the float 324 to allow droplets of the adhesive 318 to be added to an interior surface of the air gap 330. The passage 332 can then be back filled with a suitable material, such as an adhesive or epoxy 334.

Returning to FIG. 2, the cross-sectional shape of the plug 214 and the opening 206 are the same but are not limited to having a circular cross section described above. In other embodiments, the opening 206 and plug 214 can have an elliptical, a square, a triangular, a rectangular, a pentagonal, or any other suitable cross-sectional shape that enables the plug 214 to be inserted into the opening 206 to form an air gap with an air- and fluid-tight seal.

The ribs 210 are sized to be approximately equal to, or slightly greater than, the inner diameter of the tube 102, and the main body 212 is sized to have an outer diameter that is less than the inner diameter of the tube 102, thereby defining annular gaps or channels 304 between the outer surface of the body 212 and the inner wall of the tube 102. FIG. 3A includes an enlargement 306 of an annular gap 304 formed by the inner wall of the tube 102, main body 212, and ribs 210. The body 212 occupies much of the cross-sectional area of the tube 102 with the annular gaps 304 sized to substantially contain a target material. The size of the annular gaps 304 are determined by the distance between adjacent ribs 210 and the distance between the outer surface of the body 212 and the inner wall of the tube 102.

The ribs 210 may substantially seal a portion of the target material within at least one of the annular gaps 304. Any seal formed between a rib 210 and the inner wall of the tube 102 may form a fluid-tight seal. The term “seal” is also intended to encompass near-zero clearance or slight interference between the ribs 210 and the inner wall of the tube 102. The ribs 210 may also provide a support structure for the tube 102. However, in alternative embodiments, the ribs 210 can be omitted or the ribs 210 can be discontinuous or segmented with one or more openings providing the suspension 106 fluid at least one path in and out of the annular gaps 304.

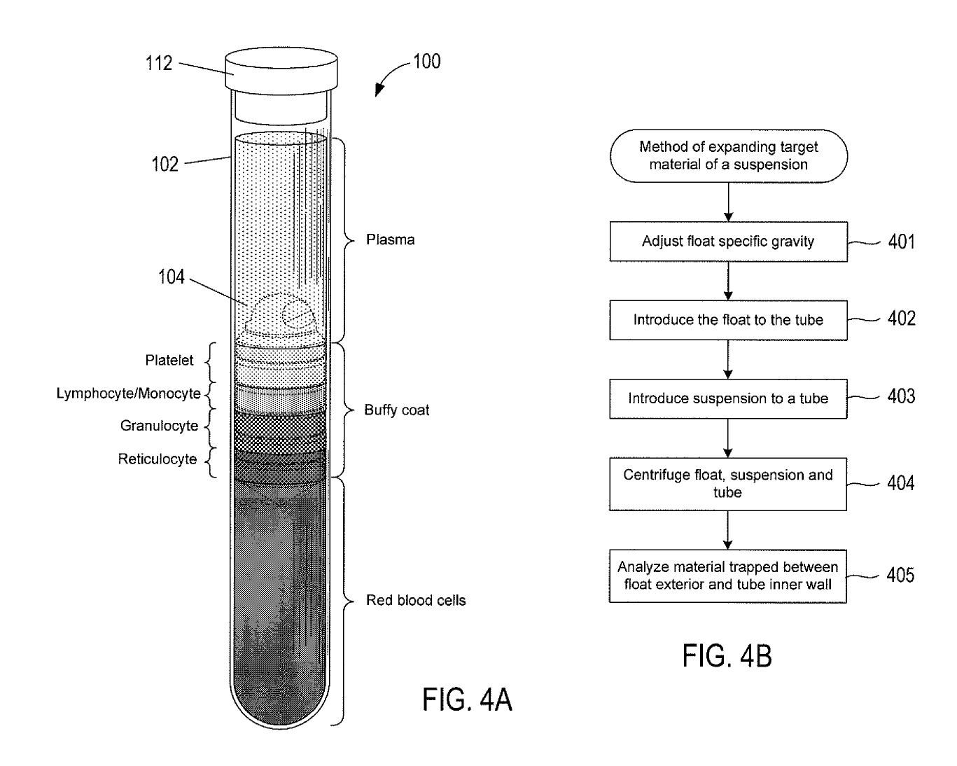

FIG. 4A shows an example of the tube and float system 100 used to trap and spread a buffy coat of a blood sample. Prior to centrifuging the blood sample contained in the tube 102, the specific gravity of the float 104 is programmed such that the float 104 is positioned at approximately the same level as the buffy coat. For example, the specific gravity of the float 104 can be set by selecting an insert 204 with an appropriate plug 214 length. The float 104 is then inserted into the tube 102 followed by introducing the blood sample to the tube 102, or the float 104 can be inserted after the blood sample has been introduced to the tube 102. The tube 102, blood sample, and float 104 are then centrifuged for an appropriate period of time, enabling the materials of the blood sample to separate axially into layers along the length of the tube 102 according to their associated specific gravities. When a blood sample is centrifuged without a float, the blood separates into a thin buffy coat layer located between a blood cell layer and a plasma layer. In particular, the blood sample after centrifugation is separated into six layers: (1) packed red cells, (2) reticulocytes, (3) granulocytes, (4) lymphocytes/monocytes, (5) platelets, and (6) plasma. The reticulocyte, granulocyte, lymphocytes/monocyte, platelet layers form the buffy coat and are the layers often analyzed to detect certain abnormalities and cancer. However, the layers comprising the buffy coat are thin and can be difficult to extract for analysis. By contrast, FIG. 4A shows the float 104 used to expand the buffy coat, enabling the expanded buffy coat to be analyzed through the tube 102 wall.

FIG. 4B shows a flow diagram summarizing a method of expanding a layer containing a target material of a suspension. In block 401, the specific gravity of a programmable float is selected so that the float comes to rest at the level of the layer suspected of containing the target material during centrifugation. The specific gravity of the float can be selected as described above with reference to FIGS. 3B-3C, or the specific gravity of the float can be selected as described below with reference to other float configurations. In block 402, the float is inserted into a tube. In block 403, a suspension suspected of containing a target material is added to the tube. In block 404, the tube, float and suspension are centrifuged to separate various particle components of the suspension according to their associated specific gravities. In block 405, the material trapped in the thin layer between the main body of the float and inner wall of the tube is analyzed to determine the presence of the target material.

The float exterior 202 and the insert 204 can be composed of the same materials or composed of different materials. The material used to form the float exterior 202 and the insert 204 include, but are not limited to, rigid organic or inorganic materials, and rigid plastic materials, such as polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrite butadiene-styrene copolymer (“ABS”) and others.

Returning to FIGS. 2 and 3, when the plug 214 is inserted into the opening 206 such that the surface 226 engages the ledge 224, an air-tight and fluid-tight seal of the air gap can be created in a number of different ways. In certain embodiments, an air- and fluid-tight seal can be created by applying an adhesive or epoxy between the surface 226 and the ledge 224. The adhesive fastens the plug 214 to the float exterior 202 and seals the air gap. In other embodiments, the air gap between the plug 214 and the float exterior 202 can be sealed by welding the seam between the surface 226 and the ledge 224. For example, the plug 214 and the float exterior 202 can be welded together along the seam using ultrasonic welding or laser welding.

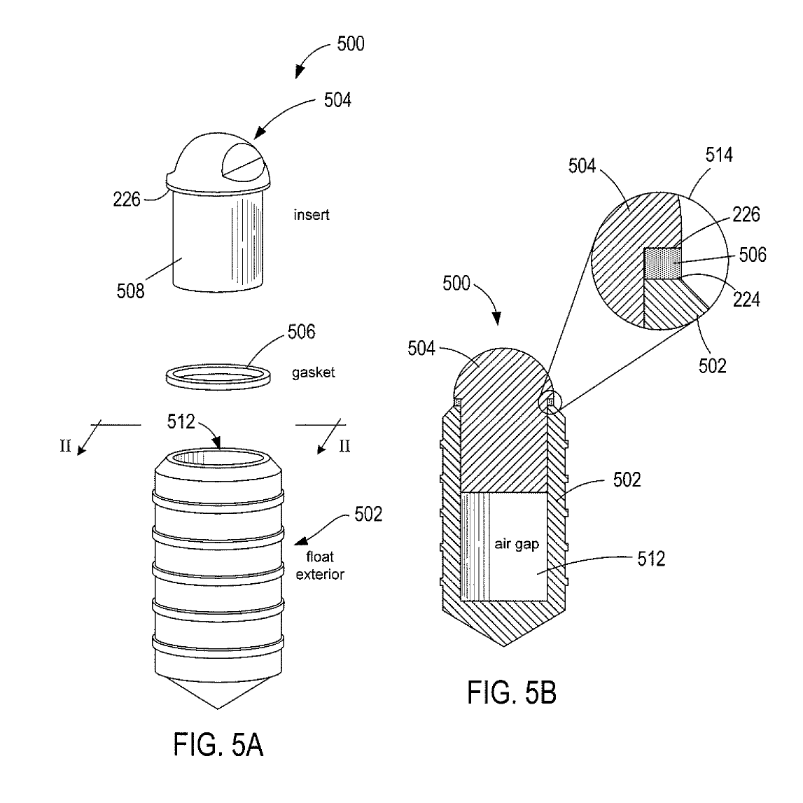

In alternative embodiments, the float can include a gasket to seal the air gap. FIG. 5A shows an exploded isometric view of an example float 500. The float 500 includes a float exterior 502, an insert 504, and a gasket 506. The float exterior 502 is identical to the float exterior 202. The insert plug 508 may include an annular groove located near the surface 226 into which the gasket 506 can be inserted. FIG. 5B shows a cross-sectional view along a line II-II, shown in FIG. 5A, of the insert 504 inserted into the opening 512 of the float exterior 502. FIG. 5B includes an enlargement 514 of the gasket 506 compressed between the surface 226 of the insert 504 and the ledge 224 of the float exterior 502 to fill the region between the surface 226 and the ledge 224 fanning an air- and fluid-tight seal. Note that an adhesive may also be used to adhere the gasket to the surface 226 and the ledge 224.

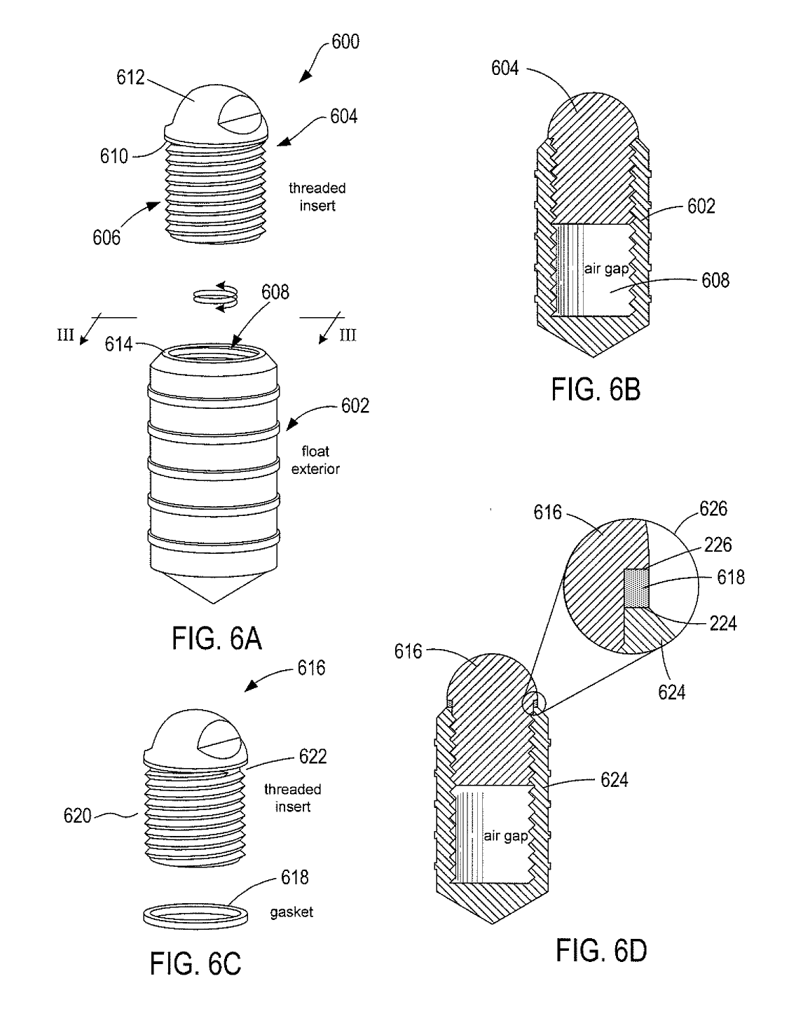

In alternative embodiments, the plug of the insert and the opening of the float exterior can be threaded. FIG. 6A shows an isometric view of an example screw-fit float 600. The float 600 includes a float exterior 602 and an insert 604. As shown in FIG. 6A, the outer surface of the insert plug 606 and inner wall of an opening 608 formed in the float exterior 602 have matching helical threads. The plug 606 portion of the insert 604 can be screwed into the opening 608. When the insert 604 is fully screwed into the opening 608, a surface 610 of head 612 engages a ledge 614 of the float exterior 602 trapping air in an air gap between the plug 606 and the bottom of the opening 608 and prevents fluid from leaking into the opening 608. FIG. 6B shows a cross-sectional view along a line shown in FIG. 6A, of the insert 604 screwed into the opening 608 of the float exterior 602. The threaded plug 606 and opening 608 is an alternative to a float described above, because the interlocking helical threads of the plug 606 and opening 608 may also provide a substantially air- and fluid-tight seal of the air gap. FIG. 6C shows an isometric view of an insert 616 and a gasket 618. The insert plug 620 includes an annular gap 622 into which the gasket 618 is inserted. FIG. 6D shows a cross-sectional view of the insert 616 inserted into the opening of a float exterior 624 with a threaded opening. FIG. 6D includes an enlargement 626 of the gasket 618 compressed to substantially fill the space between the surface 226 and the ledge 224 forming an air- and fluid-tight seal. An adhesive may also be used to adhere the gasket to the surface 226 and the ledge 224.

Note the float 600 is also a “programmable float” because the specific gravity or buoyancy of the float 606 can be changed or selected by selecting an insert with an appropriate plug length and/or mass, as described above with reference to FIGS. 3B-3D.

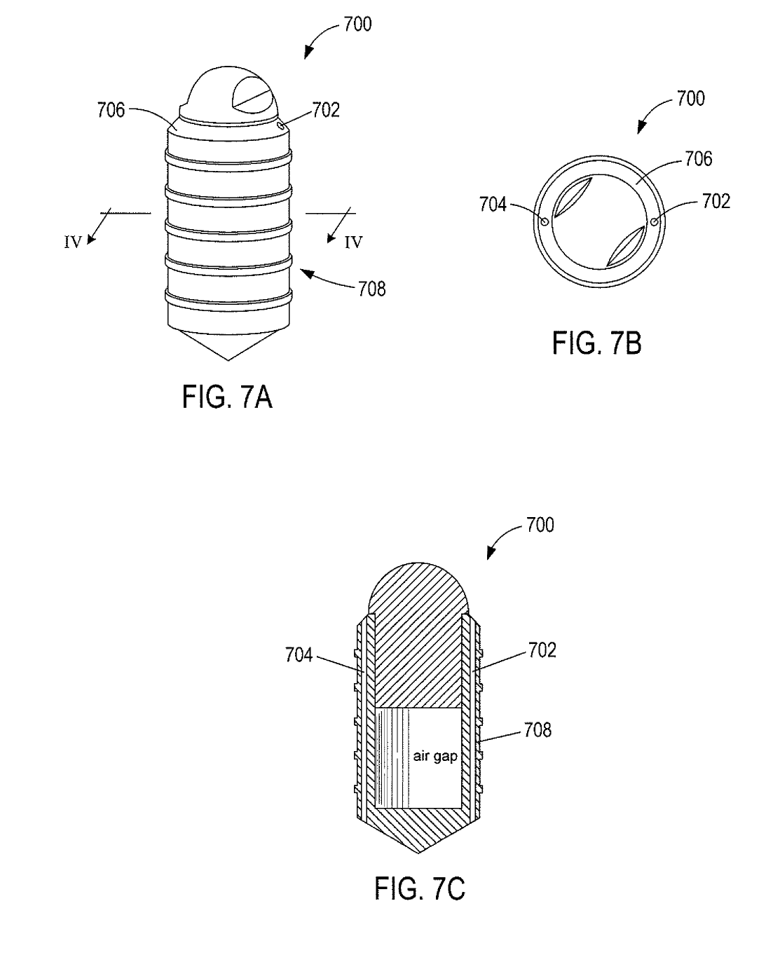

In alternative embodiments, the programmable float can include a pressure release system to alleviate pressure that builds up in the fluid trapped below the float during centrifugation. The pressure release system prevents the material or particles trapped in the fluid below the float from being forced into the annular gap, which contains the target material. FIG. 7A shows an isometric view of an example float 700, and FIG. 7B shows a top view of the float 700. The float 700 can be configured as described above with reference to FIGS. 2, 5, and 6. In the example of FIGS. 7A and 7B, the float 700 includes two bore holes 702 and 704 located in angled surface 706 of float exterior 708. FIG. 7C shows a cross-sectional view of the float 700 along a line IV-IV, shown in FIG. 7A. FIG. 7C shows the two bore holes 702 and 704 located within and extending the length of the float exterior 708 wall. As centrifugation is slowed, pressure may build up in the fluid fraction trapped below the float 700. This pressure may cause fluid to be forced into the one or more annular gaps described above with reference to FIG. 5, thus making detection of the contents of the target material more difficult. Alternatively, the collapse of the side wall of the tube during deceleration may produce excessive or disruptive fluid flow through the annular gap. The bore holes 702 and 704 allow for any excessive fluid flow or any resultant pressure in the dense fractions trapped below the float 700 to be relieved. The excess fluid flows into the bore holes 702 and 704, thus preventing degradation of the trapped target material. Note that embodiments described herein are not limited to the float exterior containing two bore holes. In other embodiments, the float exterior can include one bore hole or the float exterior can include three or more bore holes distributed around the opening and located within the float exterior wall.

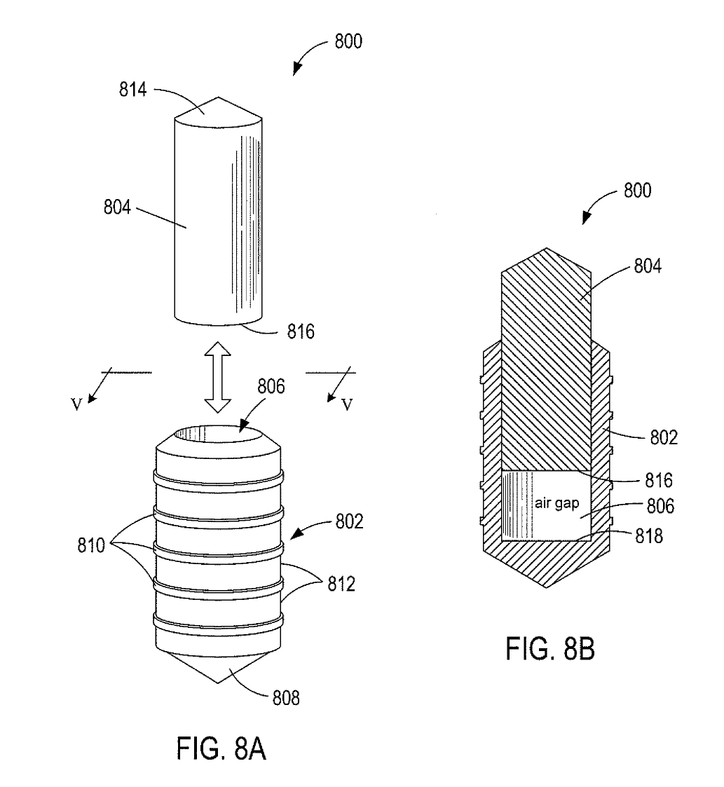

System embodiments also include floats where the specific gravity or buoyancy of the float can be changed by setting the depth to which an insert is inserted into a float exterior. FIG. 8A shows an isometric view of an example float 800. The float 800 includes a float exterior 802 and an insert 804. The float exterior 802 includes a cylindrical-shaped opening 806, a closed cone-shaped tapered end 808, and five ribs 810 with diameters that are greater than the diameter of the main body 812. The ribs 810 may be separately formed and attached to the main body 212, or the ribs 210 and the main body 812 can form a single structure. The insert 804 has a cylindrical shape with a first cone-shaped tapered end 814 and a second end 816. The diameter of the insert 804 is slightly larger, approximately the same, or slightly smaller than the diameter of the opening 806, as described above with referene to FIG. 2. FIG. 8B shows a cross- sectional view of the float 800 along a line V-V, shown in FIG. 8A. In FIG. 8B, an air gap is formed between the bottom 816 of the insert 804 and bottom 818 of the opening 806. The specific gravity of the float 800 is programmed by placing the insert 804 into the opening 806 to a depth corresponding to a desired specific gravity.

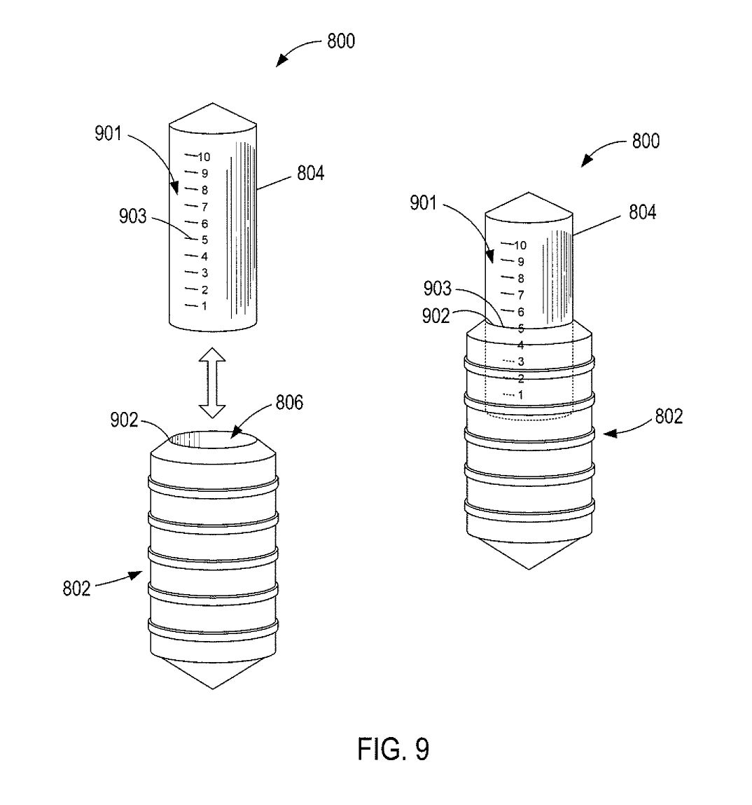

In other embodiments, a scale can be included on the outer surface of the insert 804 and can be used to control and set the depth to which the insert 804 is inserted in the float exterior 802. The scale can correspond to the buoyancy or the specific gravity of the float 800. FIG. 9 shows an isometric view of the float 800 with the insert 804 removed from the opening 806 of the float exterior 802. The insert 804 includes an example scale 901 recorded along the outer surface of the insert 804. The example scale 901 is composed of a series of marks and associated numbers. The depth to which the insert 804 is inserted into the opening 806 can be determined by looking at where the edge 902 of the float exterior 802 intersects the scale 901. FIG. 9 shows the insert 804 inserted into the opening 806 to a depth of “5” on the scale 901 as indicated by the mark 903 aligned with the edge 902. In the example of FIG. 9, when the insert 804 is inserted to a depth corresponding to larger numbers on the scale 901, the volume vₐᵢᵣ is smaller than when the insert 804 is inserted to a depth corresponding to smaller scale numbers. The large scale numbers correspond to a small volume vₐᵢᵣ, larger specific gravity, and less buoyancy than smaller scale numbers which correspond to larger volumes vₐᵢᵣ, smaller specific gravity, and more buoyancy.

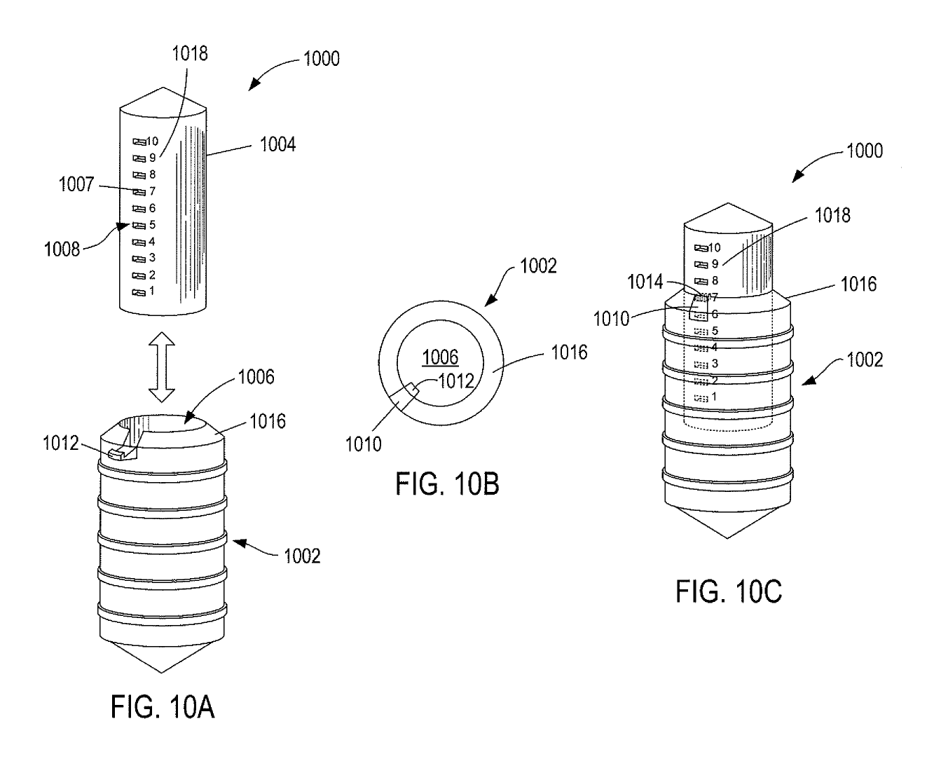

In other embodiments, the float can be configured with a locking mechanism that holds the insert to a desired depth within the opening of the float exterior during centrifugation. FIGS. 10A-10C show three different views of an example float 1000 including a locking mechanism. As shown in FIG. 10A, the float 1000 includes a float exterior 1002 and an insert 1004 removed from an opening 1006. The locking mechanism of the float 1000 includes a series of regularly spaced notches 1008 formed within, and extending along the length of, the shaft of the insert 1004. The locking mechanism also includes a latch 1010 located along the edge of the opening 1006. The latch 1010 includes a peg 1012 sized to fit within the notches 1008. The latch 1010 can be pivoted between an open position and a closed position. In FIG. 10A, the latch 1010 is in an open position enabling the insert 1004 to be positioned within, or removed from, the opening 1006. FIG. 10B shows a top view of the float exterior 1002 with the latched placed in a closed position. FIG. 10C shows an isometric view of the insert 1004 inserted into the opening 1006 to a desired depth and the latch 1010 closed with the peg 1012 inserted into a notch 1014, preventing the insert 1004 from sliding within the opening during centrifugation. In the embodiment shown in FIGS. 10A-10C, the latch 1010 is configured to form a nearly continuous portion of the edge 1016 when closed.

As shown in the example of FIG. 10, the float 1000 can also include a scale 1018, as described above. The scale is used to set the depth to which the insert 204 is inserted in the float exterior, buoyancy, or the specific gravity of the float 1006. In the example float 1000, each numerical scale 1018 value corresponds to one notch in the series of notches 1008. For example, in FIG. 10C, the peg 1012 of the latch 1010 is inserted into the notch 1014 identified by the scale number “7.”

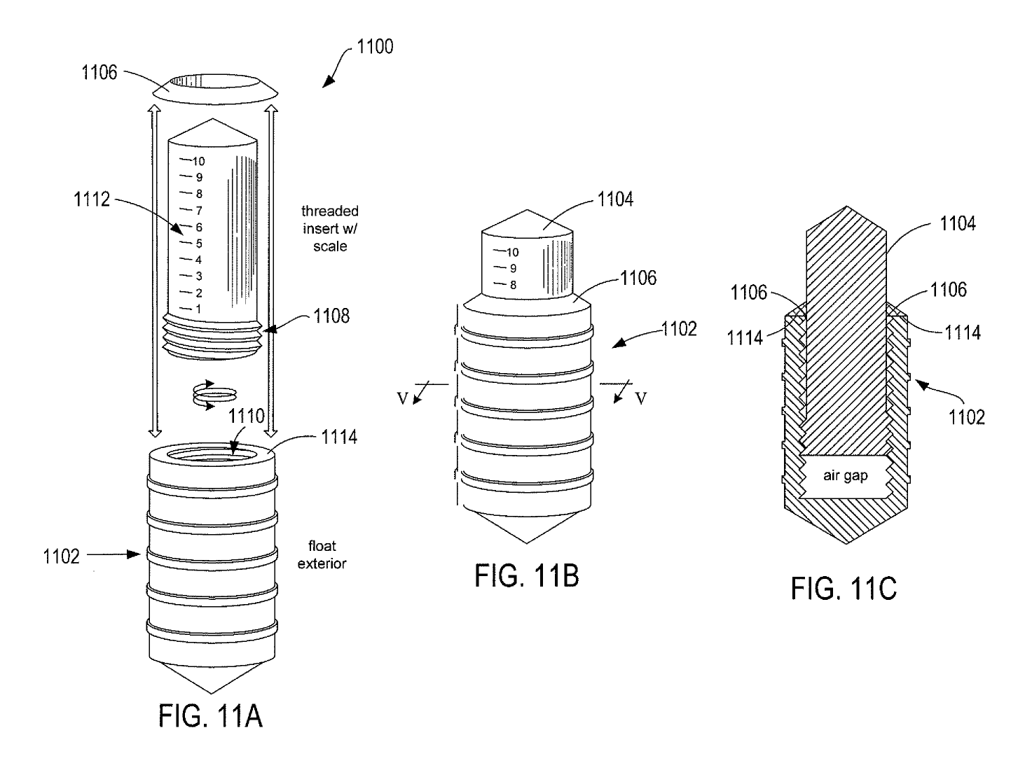

In other embodiments, the insert and the opening of the float exterior can be threaded, and the insert can include a scale to set the depth to which the insert is inserted in the float exterior, buoyancy, or the specific gravity of the float. FIG. 11A shows an isometric view of an example float 1100. The float 1100 includes a float exterior 1102, an insert 1104, and a detachable sealing ring or gasket 1106. As shown in FIG. 11A, a portion 1108 of the outer surface of the insert 1104 and the inner wall of the opening 1110 of the float exterior 1102 are configured with matching helical threads. The outer surface of the insert 1104 includes a scale 1112 composed of a series of marks and associated numbers recorded on the shaft of the insert 1104, as described above with reference to FIG. 9. The insert 704 can be screwed into the opening 1110 to a desired depth, and the sealing ring 1106 attached to the edge 1114 of float exterior 1102. FIG. 11B shows an isometric view, and FIG. 11C shows a cross-sectional view along a line V-V, shown in FIG. 11B, of the insert 1104 screwed into the opening 1110. The diameter of the sealing ring 1106 opening is smaller than the diameter of the shaft of the insert 1104 and is pressed into place against the edge 1114 of the float exterior 1102. The detachable sealing ring 1106 forms a seal that prevents fluid from entering the threads of the threaded opening 1110 and further prevents fluid from entering the air gap.

In alternative embodiments, the sealing ring 1106 and the float exterior 1102 can be a single structure. Because the opening of the sealing ring 1106 has a smaller diameter than the shaft of the insert 1104 to prevent fluid from entering the threads, the insert 1104 is inserted into the opening 1110 by forcing the threads of the insert 1104 through the opening of the sealing ring 1106 to engage the threads of the opening 1110.

Air- and fluid-tight seals can be created between the inserts and the float exteriors of the example floats 800-1100 by applying an adhesive or epoxy between the surface of the insert and the inner wall of the float exterior. The adhesive or epoxy fastens the insert to the float exterior and seals the air gap. In other embodiments, the air gap between an insert and a float exterior can be sealed by welding the seam between the inert and the edge of the opening in the float exterior. Examples of suitable welding processes include ultrasonic welding and laser welding.

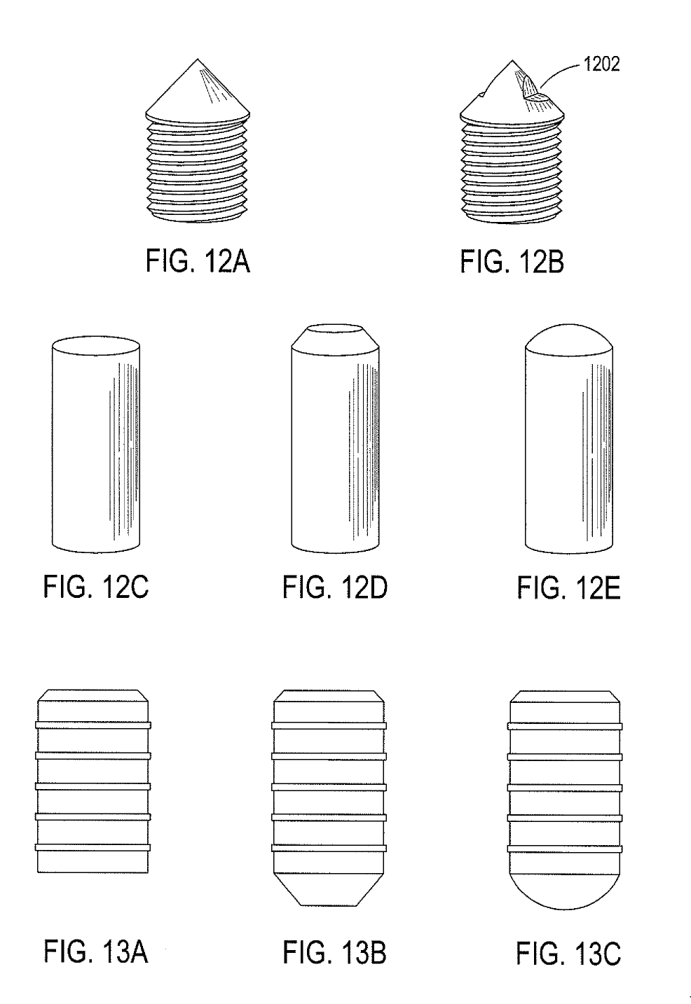

Embodiments include other types of geometric shapes for the head of the insert described above with reference to FIGS. 1-6. FIG. 12A shows a cone-shaped head of an insert, and FIG. 12B shows a cone-shaped head of an insert with finger grips 1202. The inserts in FIGS. 8-11 are configured with a cone-shaped end cap that directs the flow of fluid around the float. Embodiments include other types of geometric shapes for end caps. FIGS. 12C-12E each show one of three geometric shapes for insert end caps. In FIG. 12C, the insert includes a flat or planar end cap. In FIG. 12D, the insert includes a truncated cone-shaped end cap. In FIG. 12E, the insert includes a convex or dome-shaped end cap.

As shown in FIGS. 8-11, the float exterior is configured with a cone-shaped end cap that directs the flow of fluid around the float. Embodiments include other types of geometric shapes for a float exterior end cap. FIGS. 13A-13C each show one of three geometric shapes for float exterior end caps. In FIG. 13A, the float exterior includes a flat or planar end cap. In FIG. 13B, the float exterior includes a truncated cone-shaped end cap. In FIG. 13C, the float exterior includes a convex or dome-shaped end cap.

Embodiments include many other geometrical shapes for the end caps including concave or convex configurations and providing a curved, sloping, and/or tapered surface around which the fluid may flow during centrifugation. Additional exemplary shapes include, but are not limited to, tectiform and truncated tectiform; three, four, or more sided pyramidal and truncated pyramidal; ogival or truncated ogival; and geodesic shapes.

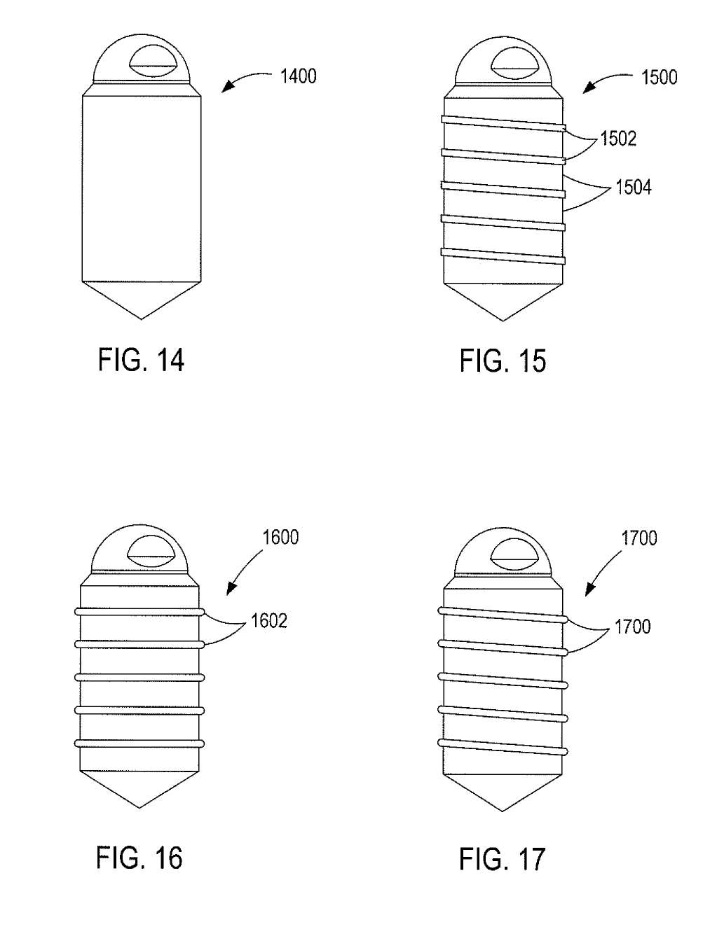

In other embodiments, the main body of the float exterior can be configured with a variety of different support structures for separating target materials, supporting the tube wall, or directing the suspension fluid around the float during centrifugation. FIGS. 14-24 show just eleven examples of different types of main body structural configurations that can be included in the main body of the float exterior. Embodiments are not intended to be limited to these eleven examples.

In FIG. 14, structures are omitted from the main body of a float 1400. The main body of the float 1400 has a smooth cylindrical outer surface.

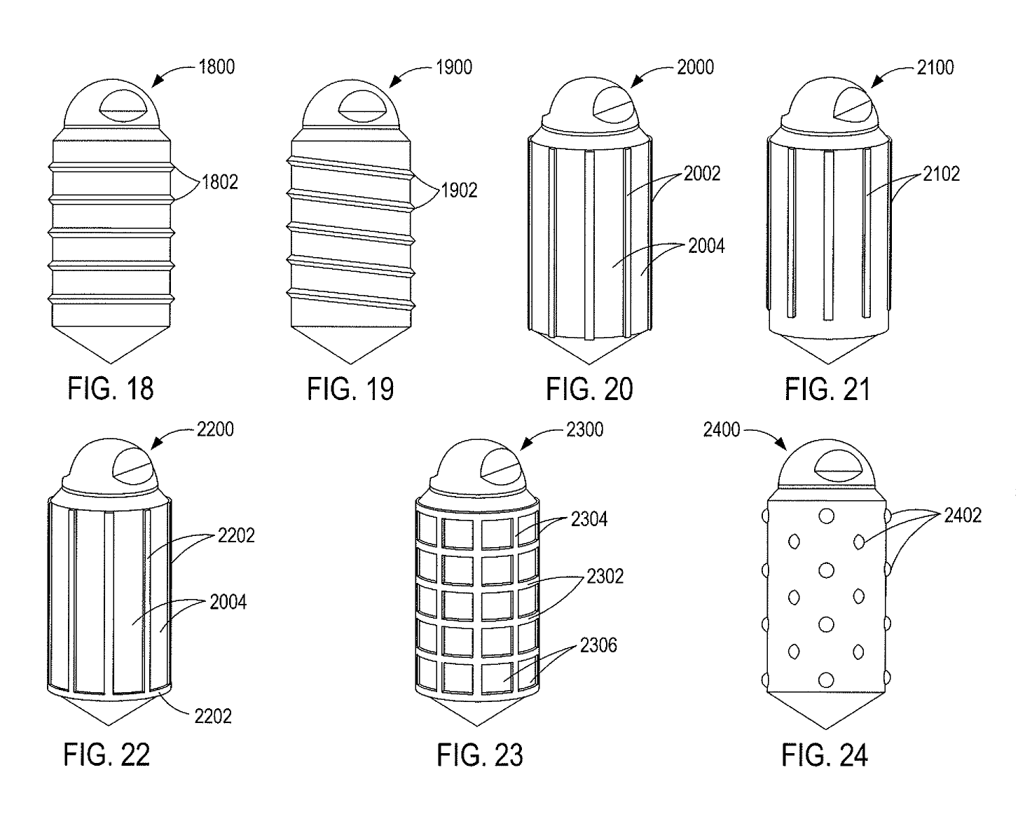

In FIG. 15, the body of a float exterior 1500 includes a single continuous helical structure or ridge 1502 creating a helical channel 1504. In other embodiments, the helical ridge can be broken or segmented to allow fluid to flow between adjacent turns of the helical channel 1504. In various embodiments, the helical rib spacing and rib thickness can be independently varied. The float exteriors 1600 and 1700 shown in FIGS. 16 and 17, respectively, are similar to the float exteriors 202 and 1500 shown in FIGS. 2 and 15, but the annular ribs 1602 of the float exterior 1600 and helical rib 1702 of the float exterior 1700 are curved or have a rounded profile. The float exteriors 1800 and 1900 shown in FIGS. 18 and 19, respectively, are also similar to the float exteriors 1600 and 1700 shown in FIGS. 16 and 17, but the annular ribs 1802 of the float exterior 1800 and helical rib 1902 of the float exterior 1900 are radially tapered.

In FIG. 20, the body of a float exterior 2000 includes a number of radially spaced, axially oriented splines 2002. The splines 2002 are configured to provide a sealing engagement with the inner wall of the tube when centrifugation is stopped. The open regions between splines 2002 form fluid retention channels 2004 between the inner wall of the tube and the body of the float exterior 2000. The surfaces of the body between the splines can be flat, curved or have another suitable geometry. In alternative embodiments, the number of splines, spline spacing, and spline thickness can each be independently varied. The splines 2002 can also be broken or segmented.

In FIG. 21, the body of the float exterior 2100 is similar to the body of the float exterior 2000 except he float exterior 2100 includes a number of radially spaced, axially oriented splines 2100 that do not extend the length of the main body leaving a smooth portion of the main body near the cone-shaped end. The smooth portion may have a number of different uses. For example, a gasket can be placed on the smooth portion of the main body.

In FIG. 22, the body of a float exterior 2200 includes a number of radially spaced, axially oriented splines 2002, as described above for the float exterior 2000, and includes a single circular rib 2202 located along the edge of the float exterior. The circular rib 2202 operates as a sealing ring to prevent particles trapped below the circular rib 2202 from entering the retention channels 2004.

In FIG. 23, the body of the float exterior 2300 includes a network of intersecting annular ribs 2302 and splines 2304. The network of annular ribs 2302 and splines 2304 form a support structure and create a number of fluid retention chambers 2306 formed between the inner wall of the tube and the body of the float exterior. The surface of the body in the retention chambers can be flat, curved, or have another suitable geometry. In alternative embodiments, the number of ribs and splines, rib and spline spacing, and rib and spline thickness can each be independently varied. The ribs 2302 and splines 2304 can also be broken or segmented.

In FIG. 24, the body of the float exterior 2400 includes a number of protrusions 2402 that provide support for the deformable tube. In alternative embodiments, the number and pattern of protrusions can be varied.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented for purposes of illustration and description. They are not intended to be exhaustive of or to limit this disclosure to the precise fowls described. Obviously, many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

1. A system for separating a target material in a suspension comprising:
a tube having an elongated sidewall of a first cross-sectional shape to hold the suspension; and
a programmable float having the same first cross-sectional shape as the tube, wherein the float is to be programmed with a specific gravity such that when the tube, float, and suspension are centrifuged together to separate various materials suspended in the suspension into different layers along the axial length of the tube, the float is to be positioned at approximately the same level as a layer containing the target material.

2. The system of claim 1, wherein the tube further comprises an open end to receive the suspension and the programmable float.

3. The system of claim 1, wherein the programmable float further comprises:
a float exterior having an opening and an exterior main body; and
an insert that fits within the opening to create an air gap within the float.

4. The system of claim 3, wherein the insert further comprises:
a head;
a plug that extends from the head; and
a flat annular-shaped surface that surrounds the base of the plug, the plug having the same cross-sectional shape as the opening in the float exterior, wherein when the plug is inserted into the opening, the flat annular-shaped surface engages a ledge of the float exterior that surrounds the opening.

5. The system of claim 4 further comprising a gasket disposed between the flat annular-shaped surface and the ledge, wherein the gasket is to be compressed between the surface and the ledge to form an air-tight and a fluid-tight seal of the air gap.

6. The system of claim 3, wherein the insert further comprises:
a head;
a plug that extends from the head; and
a flat annular-shaped surface that surrounds the base of the plug, wherein the outer surface of the plug and inner wall of the opening of the float exterior have matching helical threads, wherein when the plug is screwed into the opening, the flat annular- shaped surface engages a ledge of the float exterior that surrounds the opening and the interlocking helical threads hold the insert in place.

7. The system of claim 6 further comprising a gasket disposed between the flat annular-shaped surface and the ledge, wherein the gasket is to be compressed between the surface and the ledge to form an air-tight and a fluid-tight seal of the air gap.

8. The system of claim 3, wherein the insert is welded to the float exterior to create an air-tight and a fluid-tight air gap.

9. The system of claim 3, wherein the insert is adhered to the float exterior to create an air-tight and fluid-tight air gap.

10. The system of claim 3, wherein the insert further comprises the same cross- sectional shape and approximate size of the opening in the float exterior.

11. The system of claim 10, wherein the insert further comprises a locking mechanism to hold the insert to a desired depth within the opening of the float exterior, the locking mechanism including:
one or more of regularly spaced notches along the length of the insert; and
a latch located along the edge of the opening, the latch including a peg sized to fit within the notches, wherein the latch can be switched between a closed position with the peg inserted into one of the notches thereby holding the insert to a desired depth within the opening and an open position to enable the depth of the insert within the opening to be adjusted.

12. The system of claim 10, wherein the insert inserted into the opening further comprises the insert outer surface and the opening inner wall having matching helical threads to enable the insert to be screwed into the opening to a desired depth.

13. The system of claim 10, wherein the insert further comprises a scale corresponding to the specific gravity of the float.

14. The system of claim 3, wherein the float exterior further comprises one or more bore holes distributed around the opening and extending the length of a wall of the float exterior.

15. The system of claim 3, wherein the programmable float further comprises a single piece with an air gap, wherein droplets of an adhesive are disposed on a surface of the air gap to increase the mass of the float.

16. The system of claim 3, wherein the main body further comprises one or more structures that protrude from the main body to engage and support the sidewall of the tube, wherein the main body and the structures have cross-sectional dimensions less than the inner cross-sectional dimensions of the tube.

17. The system of claim 16, wherein the one or more structures further comprise one or more annular ribs.

18. The system of clam 16, wherein the one or more structures further comprise a helical rib.

19. The system of claim 16, wherein the one or more structures further comprise one or more radially spaced splines aligned parallel to an axis of the float.

20. The system of claim 16, wherein the one or more structures further comprise one or more annular ribs intersecting one or more radially spaced lines aligned parallel to an axis of the float.

21. The system of claim 16, wherein the one or more structures further comprise one or more raised protrusions distributed over the main body of the float exterior.

22. The system of claim 3, wherein the float exterior further comprises a geometric shape that directs fluid around the float.

23. The system of claim 22, wherein the geometric shape further comprises a cone- shaped tapered end cap.

24. The system of claim 22, wherein the geometric shape further comprises a dome- shaped tapered end cap.

25. The system of claim 22, wherein the geometric shape further comprises a truncated cone-shaped end cap

26. The system of claim 1, wherein the float further comprises a core composed of a second material and a shell composed of a second material, the shell formed around the core.

27. The system of claim 1, wherein the tube further comprises a two open ends caps to close each end.

28. A method for trapping a target material of a suspension, the method comprising:
introducing a suspension into a tube having an elongated sidewall of a first cross- sectional shape;
programming a float to have approximately the same specific gravity as the target material, the float having the same first cross-sectional shape to fit within the tube;
placing the float in the tube; and
centrifuging the suspension, tube, and float to axially separate materials of the suspension into layers along the length of the tube according to associated specific gravities, wherein the float spreads the target material between the float and inner sidewall of the tube.

29. The method of claim 28, wherein the tube further comprises an open end to receive the suspension and the float.

30. The method of claim 28, wherein the float further comprises:
a float exterior having an opening and an exterior main body; and
an insert configured to create a substantially sealed air gap within the opening of the float exterior.

31. The method of claim 28, wherein programming the float further comprises:
selecting a float exterior with a particular mass and volume;
selecting an insert with a particular mass and volume and to fit within an opening of the float exterior; and
inserting the insert into the opening to create an air gap with a particular volume.

32. The method of claim 31, wherein inserting the insert into the opening further comprises inserting a gasket between the insert and the float exterior to seal the air gap.

33. The method of claim 31, wherein inserting the insert into the opening further comprises adhering the insert to the float exterior with an adhesive or epoxy to seal the air gap.

34. The method of claim 31, wherein inserting the insert into the opening further comprises welding the insert to the float exterior to seal the air gap.

35. The method of claim 31, wherein inserting the insert into the opening further comprises screwing the insert into the opening, wherein the insert and opening are threaded such that the threads of the insert engage the threads of the opening sealing the air gap.

36. The method of claim 28, wherein programming the float further comprises:
forming a hole in the float to enable access to an interior air gap of the float;
depositing droplets of an adhesive to increase the mass of the float; and
filling in the hole with the adhesive or epoxy.
